(19) United States
(12) Patent Application Publication
(10) Pub. No.: US 2005/0204685 A1
(43) Pub. Date: Sep. 22, 2005

(54) CONNECTOR FOR CONNECTING FOAMED SYNTHETIC RESIN BLOCKS WHEN LAYING THE BLOCKS, AND METHOD FOR CONNECTING FOAMED SYNTHETIC RESIN BLOCKS USING THE SAME

(76) Inventors: Hee-Man Park, Kyoto (JP); Boo-Kyun Park, Osaka (JP)

Correspondence Address: PARK & SUTTON LLP, 3255 WILSHIRE BLVD, SUITE 1110, LOS ANGELES, CA, 90010, US

(21) Appl. No.: 10/904,440

(22) Filed: Nov. 10, 2004

(30) Foreign Application Priority Data
Mar. 17, 2004 (KR) 10-2004-0017824

(51) Int. Cl. G06F 17/60

(52) U.S. Cl. 52/698; 52/596; 403/403

(57) ABSTRACT

The present invention relates to a connector for connecting foamed synthetic resin blocks when laying the blocks, and a method for connecting foamed synthetic resin blocks using the same in a civil construction work (hereinafter referred to as a foamed synthetic resin block construction work) using foamed synthetic resin blocks as civil construction materials.

### BACKGROUND OF THE INVENTION

1. Field of the Invention

The present invention relates to a connector for connecting foamed synthetic resin blocks when laying the blocks, and a method for connecting foamed synthetic resin blocks using the same in a civil construction work (hereinafter referred to as a foamed synthetic resin block construction work) using foamed synthetic resin blocks as civil construction materials.

2. Description of the Background Art

Recently, a foamed synthetic resin block construction work has been adapted to a civil construction such as a road construction, a ground construction, etc. The foamed synthetic resin blocks of large sizes have been used as a fill material or a backfill material by laying the same. Here, the foamed blocks are formed of foamed polystyrene, polyurethane, etc. and have been used for various applications such as a civil construction like a road construction, a ground construction for buildings, etc.

FIG. 1 is a view illustrating the construction of a Styrofoam block connection member of the Korean utility model laid-open No. 95-25164 (laid-open date: Sep. 15, 1995) relating to the connector for foamed blocks. As shown therein, a pair of tooth shaped pins 2 each having a plurality of protruded pieces are vertically bent at a connection plate 1. FIG. 2 is a cross sectional view illustrating a foamed block construction work using a conventional connector. In a road filling construction, a leveling layer 4 is formed on an excavated surface of a basic ground. When a foamed block 3 is laid in multiple layers on an upper surface of the leveling layer 4 in a staggered shape. The foamed blocks 3 are connected using the connection plate 1. The connection plate 1 is applied between the layers of the foamed block 3 or on the upper most surface or the lateral surface.

In addition, the Japanese patent laid-open No. 2000-220145 (laid-open date: Aug. 8, 2000) invented by the inventor of the present application discloses a connector for connecting foamed blocks. FIG. 3 is a view illustrating a connector of an example of the conventional art. FIG. 4 is a cross sectional view illustrating an example that the connector of FIG. 3 is adapted to a foamed block construction work. As shown in FIG. 3, in the connector 10, a rod shaped head part 12 is arranged at an upper end of a leg part 111 in a vertical direction with respect to the leg part 111 wherein the leg part 11 has a sharp end.

As shown in FIG. 4, in the road filling construction using the conventional connector 10, a leveling layer 15 is formed on the excavated surface 14 of the basic ground 13 using sand. The foamed block 16 is laid on the upper surface of the leveling layer 15 in multiple layers in a staggered shape. A plurality of connector 10 are inserted in upward and downward directions from the upper side of the upper most foamed block 16 and pass through the foamed blocks 16 of each layer for thereby connecting the foamed blocks 16 in the upward and downward directions.

When the installation of the foamed blocks 16 is finished, a control base plate 17 is inserted into the top layer, and a soil covering work 18 is performed on the upper side of the foamed fill material for thereby finishing the road laying work. However, in the conventional art, the leg part 11 may be easily broken. Since the leg part 111 and the head part 12 are fixed during the assembling work, the work is difficult, and the head part may get protruded from the upper side of the foamed block. In the case that the above connector or the connector having the reverse triangle shape head part 12 or ring shaped head part 12 is adapted during the construction work, a certain gap may occur between the foamed blocks, so that the heights of the foamed blocks are not uniform. Therefore, water may be penetrated into the blocks or the blocks may be flooded.

### SUMMARY OF THE INVENTION

Accordingly, it is an object of the present invention to overcome the above-described problems encountered in the conventional art. It is another object of the present invention to provide a connector capable of achieving a laying work of foamed blocks and combining the same by improving the construction of a connector for thereby achieving an easier construction work.

It is further another object of the present invention to provide a method for laying and connecting a new foamed block using a novel connector according to the present invention.

To achieve the above objects, there is provided a connector for laying and connecting foamed synthetic resin blocks, comprising an X-short that is formed of a X-shaped wire material of which a crossing angle is almost a right angle, and each front end is sharp, and a concave portion is formed by bending a center portion of the X-shape structure and a bent portion is formed in such a manner that a wire material is formed in an upside down channel shape by bending an intermediate portion between the front end of the wire material and the concave portion at a right angle; and a fixing pin that is formed of a wire material having a certain length exceeding the height of the foamed block wherein one front end is sharp, and the other end is bent, and the front portion of the same is formed in a shape of an upside down U shaped hook, wherein the hook of the fixing pin is engaged with the concave portion of the X-short.

To achieve the above objects, there is provided a connector for laying and connecting foamed synthetic resin blocks, comprising an T-short that is formed of a wire material of which each front end is sharp, and a concave portion is formed by bending a center portion of the wire material and a bent portion is formed in such a manner that a wire material is formed in an upside down channel shape by bending an intermediate portion between the front end of the wire material and the concave portion at a right angle; and a fixing pin that is formed of a wire material having a certain length exceeding the height of the foamed block wherein one front end is sharp, and the other end is bent, and the front portion of the same is formed in a shape of an upside down U shaped hook, wherein the hook of the fixing pin is engaged with the concave portion of the T-short.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating an example of a conventional connection plate;

FIG. 2 is a cross sectional view illustrating a construction example of foamed synthetic resin blocks using a conventional connection plate;

FIG. 3 is a perspective view illustrating an example of a conventional connector;

FIG. 4 is a cross sectional view an example that the connector of FIG. 3 is adapted to a foamed synthetic resin block technique;

FIG. 5 is a perspective view illustrating the construction of a T-short according to the present invention;

FIG. 6 is a perspective view illustrating the construction of a X-short according to the present invention;

FIG. 7 is a perspective view illustrating a fixing pin according to the present invention;

FIG. 8 is a perspective view illustrating a T-shaped pin according to the present invention;

FIG. 9 is a perspective view illustrating a X-shaped pin according to the present invention;

FIG. 10 is a plane view illustrating an example that a connector is adapted to a one-layer foamed synthetic resin block according to the present invention;

FIG. 11 is a plane view illustrating an example that a connector is adapted to a two-layer foamed synthetic resin block according to the present invention;

FIG. 12 is a disassembled view illustrating an example that a connector is adapted to ma foamed synthetic resin block according to the present invention;

FIG. 13 is a cross sectional view illustrating an example that foamed synthetic resin blocks are adapted to a road construction according to the present invention; and

FIG. 14 is a cross sectional view illustrating an example that a connector is adapted to a public work according to the present invention.

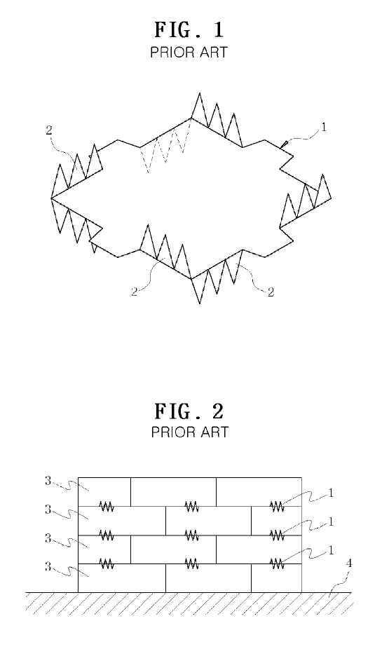

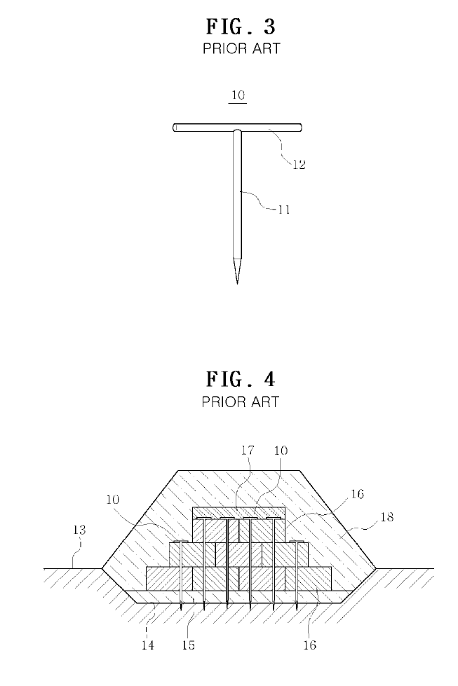

### DETAILED DESCRIPTION OF THE PREFERRED EMBODIMENTS

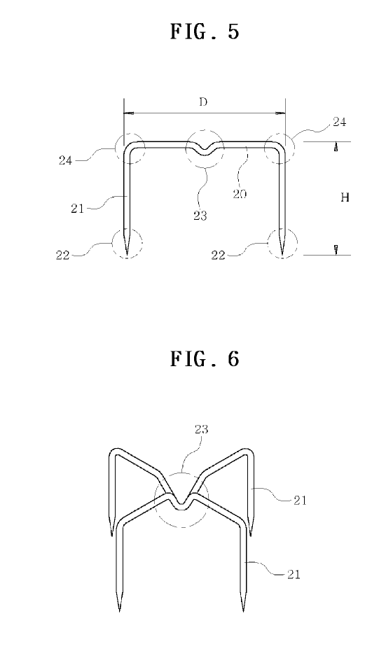

The preferred embodiments of the present invention will be described with reference to FIGS. 5 through 14.

The terminologies of the present invention will be described for better understanding of the present invention.

(1) The foamed blocks are formed of foamed Styrofoam (referred to as foamed Styrol) and are hexahedron. The size of each block is an angled material having a vertical length of 2 m, a horizontal length of 1 m, and a thickness of 1 0˜50 cm. Here, the size and shape may be changed.

(2) Construction and kind of pin

(a) T-short: The wire material in which the head part 20 is an upside down channel shape as shown in FIG. 5 is called T-short. In this embodiment of the present invention, the wire material has a diameter of 4 mm, and the length D of the head part 20 is 240 mm, and the height H of the leg part 21 is 100 mm.

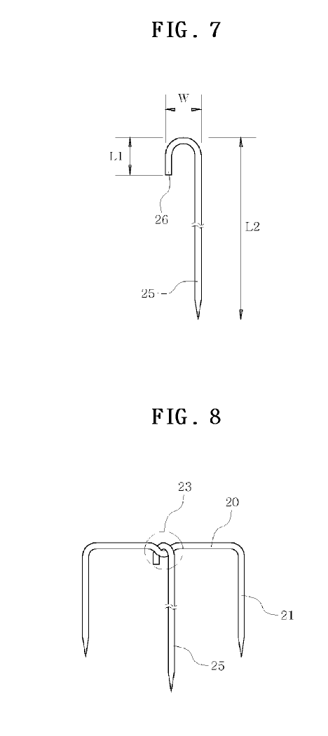

(b) X-short: As shown in FIG. 6, the wire material in which two T-short are welded in a shape of X of which a crossing angle is almost right angle is called a X-short.

(c) 650-pin: As shown in FIG. 7, the end of the fixed part 25 is sharp, and the end of the upward portion is formed in a shape of a hook 26. In the present invention, in the 650-pin, the length L2 from the front end of the leg part 25 to the apex of the upside down U shape is about 650 mm, and the length L1 of the hooking part of the hook 26 is 30 mm, and the distance W of the apex portion is 20 mm. In the present invention, the 650-pin is referred to as fixing pin.

(d) 1150-pin: 1150-pin is the wire material as 650-pin described in (c). The length from the front end of the leg part 25 to the apex of the upside down U shape of the front end of the upper side is about 1150 mm the purpose of fixing. In the present invention, the 1150-pin is referred to as fixing pin.

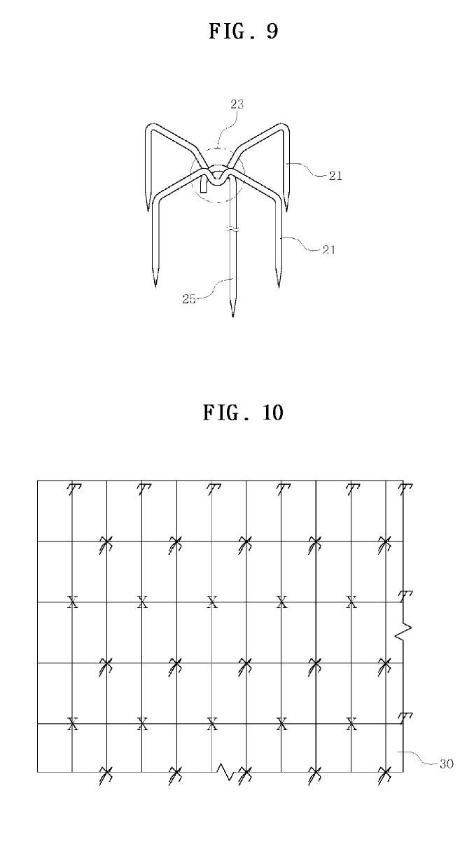

(e) T-shaped pin: As shown in FIG. 8, the T-shaped pin corresponds to a block laying type connector in which the upside down U shaped hook 26 of the 650-pin or the 1150-pin is engaged with a concave portion 23 of the T-short. In the present invention, it is defined as T-shaped pin.

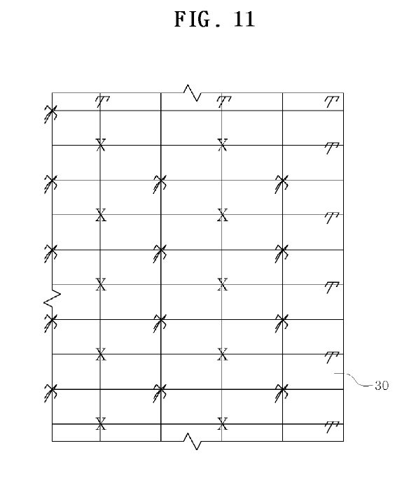

(f) X-shaped pin: As shown in FIG. 9, the X-shaped pin corresponds to a block laying type connector in which the upside down U shaped hook 26 of the 650-pin or 1150-pin is engaged with the concave portion 23 of the X-short. In the present invention, it is defined as X-shaped pin.

(g) Connector: In the present invention, the foamed blocks laid using the T-shaped pin or X-shaped pin are combined. The thusly combined structure is called a connector.

FIG. 5 is a view illustrating the T-short. As shown therein, the T-short is formed in an upside down channel shape in which the diameter is 4 mm, the length D of the head part is 240 mm, and the height H of the leg part is 100 mm. FIG. 6 is a view illustrating the X-short according to the present invention. As shown therein, two T-shorts of FIG. 5 are combined with wire materials in the X-shape of which the crossing angle is almost right angle. FIG. 7 is a perspective view illustrating the fixing pin according to the present invention. As shown therein, the front end of the fixed part 25 is sharp, and the front end of the upper side is formed in a shape of the hook 26 formed using a wire material. In this embodiment of the present invention, the length L2 from the front end of the leg part 25 to the apex of the upside down U shape structure is about 65-mm or 1150 mm, and the length L1 of the hook 26 is 30 mm, and the width of the same is 20 mm.

FIG. 8 is a perspective view illustrating the T-shaped pin according to the present invention, and FIG. 9 is a perspective view illustrating the X-shaped pin according to the present invention. Here, the T-shaped pin corresponds to a connector for laying and connecting the blocks in such a manner that the upside down U shape hook 26 of the 650-pin or 1150-pin is engaged with the concave portion 23 of the T-short.

In addition, the X-shaped pin corresponds to a connector for laying and connecting blocks combined in such a manner that the upside down U shaped hook 26 of the 650-pin or 1150-pin is engaged with the concave portion 23 of the X-short. The X-shaped pin is formed in a cross shape in which the crossing angle is almost a right angle. The front end 22 of each leg part 21 is sharp, and the center of the crossed portion is bent for thereby forming a concave portion, and the both ends of the intermediate portion between the front end 22 and the concave portion 23 is bent at a right angle, so that the bent part 24 in which the wire material is formed in an upside down channel shape is formed. The fixing pin of the upside down U shape is engaged with the concave portion 23 of the X-short.

FIG. 10 is a plane view illustrating the construction that the connector of the present invention is adapted to a one-layer foamed block. As shown therein, a plurality of foamed blocks 30 get closer from each other on the leveled ground. The edge portions of the blocks are fixed using the T-shaped pin. The interiors of the foamed blocks are fixed at regular intervals using the X-shaped pin and X-short. As shown in FIG. 10, the X-shorts are fixed at regular interval in a horizontal direction in such a manner that the pin is pressed at a portion in which four blocks meet with each other at the second block and the third block from the upper portions of the laid blocks, and the X-shaped pins are fixed in such a manner that the first and second blocks, and the even number blocks like the second block from the left side to the right side and the fourth block are arranged at regular intervals.

FIG. 11 is a plane view illustrating the construction that the connector of the present invention is adapted to a two-layer foamed block. When the block of the drawing is laid on the block of FIG. 10, the position of each block is staggered from each other for thereby uniformly distributing the total weight. Similarly with FIG. 10, the T-shaped pin is designed to fix the edge portion of the laid foamed block. The X-short and the X-shaped pin are arranged and fixed, alternately from each other.

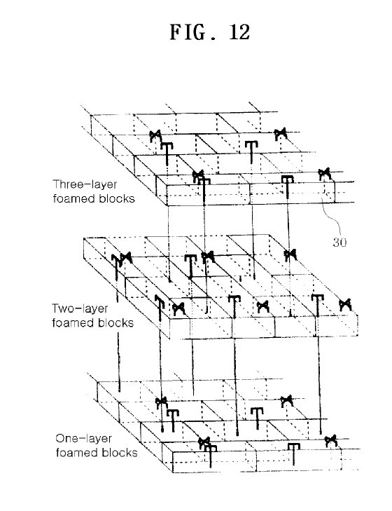

FIG. 12 is a disassembled view illustrating the construction that the connector of the present invention is adapted to the foamed blocks. As shown therein, the lower most layer of the foamed blocks is formed of one layer, and the upper most layer is formed of three layers. The T-shaped pin, X-shaped pin and X-short are adapted for fixing the laid foamed blocks un the upper, lower, left and right directions as the connectors. There are shown the depths of the insertions. The rectangular foamed blocks 30 are laid in multiple layers, staggering from each other on the same planes of the foamed blocks. The connector of the present invention is inserted into a certain portion of the upper surface of the foamed block laid surface in the upper and lower directions and is connected with the two layer foamed blocks 30. The foamed blocks 30 are integrally connected in the upper, lower, left and right directions. In particular, the work for the connector of the present invention easier as compared to the work for the conventional connector. Since the head part 20 is inserted more deeply as compared to the plane of the foamed block, it does not protrude to the outside.

The method for laying and connecting the foamed blocks will be described according to a first embodiment of the present invention.

In the method for laying and connecting the foamed blocks, there is method for laying and connecting foamed synthetic resin blocks using a connector wherein the foamed synthetic resin blocks get closer from each other and are laid on a plane, comprising a step in which a X-short is arranged so that the X-shaped center of the X-short of claim 1 is positioned at a portion in which each angled part of the upper surfaces of the foamed blocks arranged on the plane meets from each other; a step in which each front end of the X-short is inserted from an upper surface of each of four foamed blocks of the neighboring portions in a downward direction; a step in which a sharp front end of the fixing pin is inserted from a gap of each foamed block in a downward direction; a step in which the sharp front end of the fixing pin is inserted into a board surface in a downward direction in the case of foamed blocks or the lower most foamed block layer; and a step in which more foamed blocks are laid on an upper layer of the foamed blocks, and the connector of claim 2 is inserted in the same sequence with respect to the laid foamed blocks, and the foamed blocks are laid with a certain height.

The method for laying and connecting the foamed blocks will be described according to a second embodiment of the present invention. There is a method a method for laying and connecting foamed synthetic resin blocks using a connector wherein the foamed synthetic resin blocks get closer from each other and are laid on a plane, comprising a step in which a front end of a T-short of claim 3 is provided between the foamed blocks laid on a plane and is inserted into an upper surface of each foamed block in a downward direction; a step in which a sharp front end of the fixing pin of claim 3 is inserted from a gap of each foamed block in a downward direction; a step in which the sharp front end of the fixing pin is inserted into a board surface in a downward direction in the case of the foamed blocks of the foamed block layer forming a lower layer with respect to the foamed blocks or the lower most foamed block layer; and a step in which more foamed blocks are laid on an upper layer of the foamed blocks, and the connector of claim 3 is inserted in the same sequence with respect to the laid foamed blocks, and the foamed blocks are laid with a certain height.

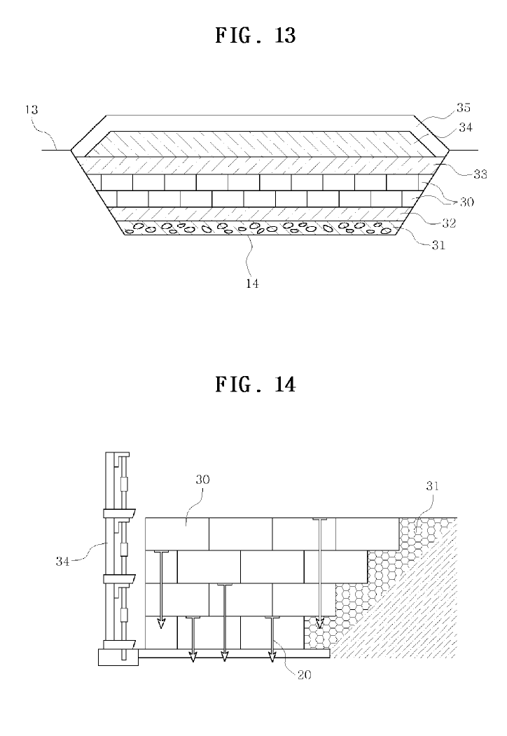

FIG. 13 is a cross sectional view illustrating the construction that the foamed blocks are adapted to the road construction. As shown therein, a basic gravel layer 31 is provided on the excavated surface 14 formed by cutting the basic ground 32. A sand mat 32 is covered on the above resultant structure. A connector is installed at a foamed block part 30. An insertion gravel layer 33 is covered on the upper side of the foamed block part 30. A concrete layer 34 is covered on the upper side of the insertion gravel layer 33. A covering soil 35 is covered on the upper side of the concrete layer 34.

FIG. 14 is a cross sectional view illustrating the construction that the connector of the present invention is adapted to a civil construction.

As shown therein, the basic ground is excavated, and one side of the excavating surface is filled with basic gravels. The foamed blocks 30 are laid at the lateral side of the same. Thereafter, the sharp end of the connector of the present invention is inserted into the lower layer of the foamed blocks or the lower most foamed blocks. The front end of the connector is inserted into the board surface in the downward direction and is inserted into the lower foamed blocks or the board surface of the lower most foamed block layer.

More foamed blocks are laid on the upper layer of the foamed blocks. The above operation is repeatedly performed with respect to the laid foamed blocks, so that the foamed blocks are sequentially laid with a certain height.

As described above, in the foamed block construction according to the present invention, the foamed blocks of at least two layers are laid in the upper, lower, left and right directions for thereby integrally connecting the blocks. In particular, in the present invention, the construction is simply and fast finished. An efficient work is achieved. In addition, the connector according to the present invention is easier as compared to the conventional connector. Since the head part is inserted deeper than the plane of the foamed blocks, it does not protrude to the outside.

In addition, it is possible to maintain the plane state of the foamed blocks during a long time period using the connector of the present invention for the laid foamed blocks, so that a stable laid and connected foamed block can be obtained for thereby preventing a water leakage and water penetration.

The connector for connecting the foamed blocks and a method for connecting the foamed blocks using the same according to the present invention can be well adapted to various civil constructions such as a road construction, a land construction, a part or garden fill construction, a mountain land sliding site, etc.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A connector for laying and connecting foamed synthetic resin blocks, comprising:
an X-short that is formed of a X-shaped wire material of which a crossing angle is almost a right angle, and each front end is sharp, and a concave portion is formed by bending a center portion of the X-shape structure and a bent portion is formed in such a manner that a wire material is formed in an upside down channel shape by bending an intermediate portion between the front end of the wire material and the concave portion at a right angle; and
a fixing pin that is formed of a wire material having a certain length exceeding the height of the foamed block wherein one front end is sharp, and the other end is bent, and the front portion of the same is formed in a shape of an upside down U shaped hook,
wherein the hook of the fixing pin is engaged with the concave portion of the X-short.

2. The connector of claim 1, wherein said fixing pin is formed of a wire material and has a length of about 650 mm or 1150 mm from the front end of the leg part of the apex of the upside down U shape, and the length of the hooking portion of the hook is 30 mm, and the distance of the apex portion is 20 mm.

3. A connector for laying and connecting foamed synthetic resin blocks, comprising:
a T-short that is formed of a wire material of which each front end is sharp, and a concave portion is formed by bending a center portion of the wire material and a bent portion is formed in such a manner that a wire material is formed in an upside down channel shape by bending an intermediate portion between the front end of the wire material and the concave portion at a right angle; and
a fixing pin that is formed of a wire material having a certain length exceeding the height of the foamed block wherein one front end is sharp, and the other end is bent, and the front portion of the same is formed in a shape of an upside down U shaped hook,
wherein the hook of the fixing pin is engaged with the concave portion of the T-short.

4. The connector of claim 3, wherein said T-short is formed of a wire material and has a diameter of 4 mm, and the length of a head part is 240 mm, and the length of the leg part is 100 mm.

5. A method for laying and connecting foamed synthetic resin blocks using a connector wherein the foamed synthetic resin blocks get closer from each other and are laid on a plane, comprising:
a step in which a X-short is arranged so that the X-shaped center of the X-short of claim 1 is positioned at a portion in which each angled part of the upper surfaces of the foamed blocks arranged on the plane meets from each other;
a step in which each front end of the X-short is inserted from an upper surface of each of four foamed blocks of the neighboring portions in a downward direction;
a step in which a sharp front end of the fixing pin is inserted from a gap of each foamed block in a downward direction;
a step in which the sharp front end of the fixing pin is inserted into a board surface in a downward direction in the case of foamed blocks or the lower most foamed block layer; and
a step in which more foamed blocks are laid on an upper layer of the foamed blocks, and the connector of claim 2 is inserted in the same sequence with respect to the laid foamed blocks, and the foamed blocks are laid with a certain height.

6. A method for laying and connecting foamed synthetic resin blocks using a connector wherein the foamed synthetic resin blocks get closer from each other and are laid on a plane, comprising:
a step in which a front end of a T-short of claim 3 is provided between the foamed blocks laid on a plane and is inserted into an upper surface of each foamed block in a downward direction;
a step in which a sharp front end of the fixing pin of claim 3 is inserted from a gap of each foamed block in a downward direction;
a step in which the sharp front end of the fixing pin is inserted into a board surface in a downward direction in the case of the foamed blocks of the foamed block layer forming a lower layer with respect to the foamed blocks or the lower most foamed block layer; and
a step in which more foamed blocks are laid on an upper layer of the foamed blocks, and the connector of claim 3 is inserted in the same sequence with respect to the laid foamed blocks, and the foamed blocks are laid with a certain height.
